(19) United States
(12) Patent Application Publication
(10) Pub. No.: US 2009/0207722 A1
(43) Pub. Date: Aug. 20, 2009

(54) OPTICAL DISC APPARATUS

(75) Inventors: Morio Nakatani, Ichinomiya-shi (JP); Seiichiro Takahashi, Gifu-shi (JP)

Correspondence Address: DITTHAVONG MORI & STEINER, P.C., 918 Prince St., Alexandria, VA, 22314, US

(73) Assignee: SANYO Electric Co., Ltd., Moriguchi-shi (JP)

(21) Appl. No.: 12/390,342

(22) Filed: Feb. 20, 2009

(30) Foreign Application Priority Data
Feb. 20, 2008 (JP) 2008-039415

(51) Int. Cl. G11B 7/00

(52) U.S. Cl. 369/275.3; G9B/7

(57) ABSTRACT

An optical disc apparatus searches domain information from information stored on a disc. When the domain information is thereby acquired, the existence of the domain information is presented to outside at a predetermined timing in a reproducing process of the disc. When an access execution command based on the domain information is inputted by a user in response to this presentation, the optical disc apparatus accesses an address specified by the domain information via a network.

This application claims priority under 35 U.S.C. Section 119 of Japanese Patent Application No. 2008-39415 filed Feb. 20, 2008, entitled “OPTICAL DISC APPARATUS”.

### BACKGROUND OF THE INVENTION

1. Field of the Invention

The present invention relates to an optical disc apparatus, and more particularly relates to an optical disc apparatus suitable for use in acquiring content information from a server device over a network based on domain information recorded on an optical disc.

2. Disclosure of the Related Art

For HDDVDs (High-Definition Digital Versatile Discs; hereinafter referred to as “HD”) or blue-ray discs in which commercialization is being advanced in recent years, a player provided with a function for connecting to a network is under development. This type of player is able to reproduce not only content information recorded on the disc but also content information appropriately acquired from a server device existing in a network.

At this time, the network access function equipped in the player beforehand is used to access the server device. That is, a user selects the network access function using a remote controller, etc., from a function menu group of the player so as to perform input operations to execute the access.

In response to the input operation, the player specifies a file written with domain information (access destination address such as a URL) from a folder structure (tree structure) of data recorded on the disc, and reads the access destination address from this file to access the address. In this case, a folder name and a file name in the folder structure are defined by a standard. In this way, the access destination address included on the disc is accessed, and predetermined content information is delivered to the player from the server device. This allows the player to reproduce an additional content not stored on the disc.

Thus, when the disc and the server device are combined, a new business scene may be established. For example, there is configured a system composed of a disc and a server device, in which a movie content is recorded on the disc and information about its sequel is acquired from the server device over the network after the purchase of the disc. This makes it possible to raise the added value of the disc and also promote the purchase of the sequel. In this way, a new business scene using the disc is established.

In a case of the aforementioned configuration, whether it is possible to acquire an additional content from the network using the disc is usually presented to a user by a method in which it is so written on a disc package or a method in which an instruction manual written with that effect is attached to the disc. However, by these presentation methods, when the user loses the package or the instruction manual, the user becomes unable to easily know whether there are any additional contents, and there is a possibility that the user may not obtain the entitled service properly.

Even in this case, the user is still able to acquire the additional content from the server device by starting the network access function of the player. Having said that, starting the network access function requires a complicated operation such as repeating a forwarding operation in the function menu, and thus, when the user does not know whether the domain information is included on the disc, the user may not be tempted to start the network access function. Further, there may be a case that the user is not able to start the network access function itself due in part to the fact that the user does not know how to start the network access function in the first place. When this occurs, the user is not able to acquire the additional content which is especially provided for the user, and the amusement characteristics of the disc are not exhibited properly.

On the other hand, there is a case that content providers announce the sequel of the movie content to the user by executing the network function using the disc, thereby attempting the sales promotion of the sequel. Alternately, there may also be a case that an additional content that supplements the movie content contained on the disc is presented to the user after the sale of the disc, thereby enhancing the completeness or the amusement characteristic of the movie content. However, these attempts are achievable on condition that the user properly accesses the network, and therefore, the content provider needs to take some kind of measures so that the user is properly and surely able to perform network access using the disc.

### SUMMARY OF THE INVENTION

An object of the present invention is to provide an optical disc apparatus capable of properly and smoothly performing network access using a disc, for example, even when a user loses a disc package or an instruction manual.

An optical disc apparatus according to the present invention is provided with: a domain searching portion for searching domain information from information stored on a disc; a domain presenting portion for presenting existence of the domain information to outside at a predetermined timing in a reproducing process of the disc when the domain information is searched by the domain searching portion; and an access controlling portion for accessing an address specified by the domain information via a network when an access execution command based on the domain information is inputted by a user.

According to the optical disc apparatus according to the present invention, the existence of the domain information on the disc is presented to outside at a predetermined timing in a disc reproducing process. Thus, even when a user loses a disc package or an instruction manual, for example, the use is able to know the existence of the domain information on the disc properly and smoothly, and is able to appropriately perform network access using the disc.

### BRIEF DESCRIPTION OF THE DRAWINGS

The above and other objects and novel features of the present invention will become more completely apparent from the description of the embodiment below taken with the following accompanying drawings.

FIG. 1 is a diagram showing an area format of an optical disc according to an embodiment.

FIG. 2 is a diagram showing the configuration of the optical disc apparatus according to the embodiment.

FIG. 3 is a diagram showing a function block of the optical disc apparatus according to the embodiment.

FIG. 4 is a diagram showing a process flow of the optical disc apparatus according to the embodiment.

FIG. 5A and FIG. 5B are diagrams each showing a screen display example of the optical disc apparatus according to the embodiment.

FIG. 6 is a diagram showing another process flow of the optical disc apparatus according to the embodiment.

However, the drawings are for the purposes of illustration only, and are not intended to limit the scope of the present invention.

### DESCRIPTION OF PREFERRED EMBODIMENTS

An embodiment of the present invention will be described below with reference to the drawings. In the embodiment, the present invention is applied to an optical disc apparatus capable of reproducing a read only HD.

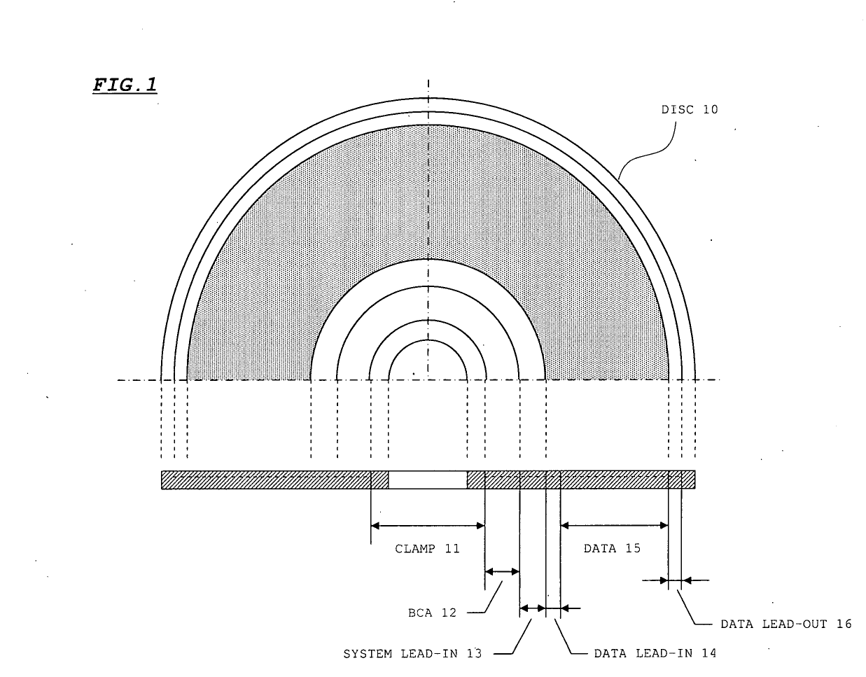

First of all, an area format of a disc 10 is shown in FIG. 1. The disc 10 is divided into areas sequentially from its inner circumference: a clamp area 11, a burst-cutting area (BCA) 12, a system lead-in area 13, a data lead-in area 14, a data area 15, and a data lead-out area 16.

In the BCA 12, predetermined information is recorded in a mode according to an HD standard. Specifically, information such as a BCA_ID and a book number of a written standard on which the disc is based are recorded by allowing a flat record layer to disappear intermittently along the disc circumference direction. Further, the BCA 12 is recorded also with types of discs, and based on this information, the book number may be matched in a player 100 so as to specify the types of discs. In addition, the presence or absence of a content protection and a part of content protection information are also recorded in the BCA 12. It is noted that the recording layer is disappeared by a method for burning and cutting off the recording layer using a high power laser, for example.

When a beam spot is positioned on the BCA 12, light and shade occur in the reflected light depending on a disappeared portion and a non-disappeared portion of the recording layer. The information recorded in the BCA 12 is reproduced by demodulating the change of the light and shade.

In the system lead-in area 13, information about physics parameters (pit size, track pitch, etc.) of the disc, a part of the content protection information, etc., are recorded by arraying a pit sequence on the record layer in a spiral. Also in the data lead-in area 14, the pit sequence is formed in a spiral, the content protection information is recorded by the pit sequence, and thus, a user is not able to access freely. In the data area 15, the pit sequence is also formed in a spiral. The content information is recorded by the pit sequence.

Herein, the content information is configured by a folder structure (tree structure). By the folder structure, the content information accommodated on the disc 10 is segmented into either a normal content not using a network connection or an advanced content in which a network connection is possible. In the advanced content, an API folder is created other than folders containing main contents such as movie information, and in this API folder, an Event folder is included. This Event folder includes a file in which whether there is setting relating to a network connection is set in Bits. A player (optical disc apparatus) is able to distinguish whether the network connection using the disc 10 is possible by referring to this file.

On the other hand, when the content information is the advanced content, a file written with domain information (an access destination address such as a URL) in a predetermined position of the folder structure (tree structure) is created. The player (optical disc apparatus) is able to distinguish whether the network connection using the disc 10 is possible by referring to whether the domain information is written in this file.

A folder name and a file name in the folder structure (tree structure) are specified by an HD standard. Therefore, the player (optical disc apparatus) may follow the folder structure (tree structure) of the advanced content thereby to specify the file in which whether there is setting relating to a network connection is set in Bits or the file written with the domain information (an access destination address such as a URL). In addition, the content may be referred thereby to distinguish whether the network connection using the disc 10 is possible.

Returning to FIG. 1, a pit sequence is formed in the data lead-out area 16 in a spiral similar to that of the data area 15. This area is arranged for the purpose of preventing a drive apparatus from driving recklessly, and information indicating that this area is a data lead-out area is recorded. It is noted that the physics parameters of the disc 10 used in this embodiment are listed as follows:

| | | Data area, data |
|---|---|---|
| | System | lead-in area, data |
| | lead-in area | lead-out area |
| Data bit length | 0.306 μm | 0.153 μm |
| Channel bit length | 0.204 μm | 0.102 μm |
| Minimum pit length | 0.408 μm | 0.204 μm |
| (2T) | | |
| Maximum pit length | 2.652 μm | 1.326 μm |
| (13T) | | |
| Track pitch | 0.68 μm | 0.4 μm |

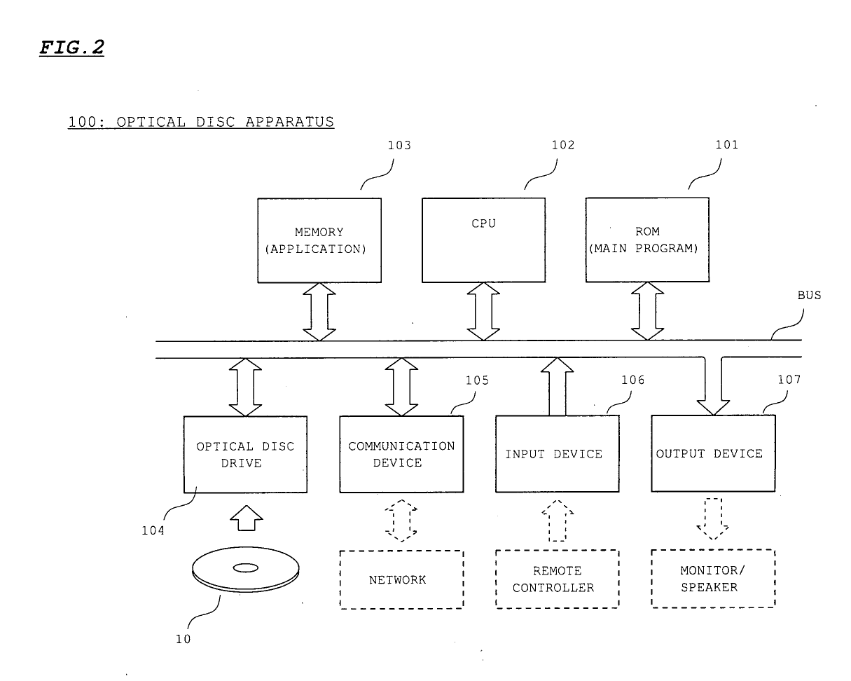

FIG. 2 is a diagram showing the configuration of an optical disc apparatus 100. As shown in FIG. 2, the optical disc apparatus 100 is provided with: a ROM (Read Only Memory) 101; a CPU (Central Processing Unit) 102; a memory 103; an optical disc drive 104; a communication device 105; an input device 106; and an output device 107.

A main program for controlling a basic operation of the optical disc apparatus 100 is stored in the ROM 101. The CPU 102 controls each part according to the main program stored in the ROM 101, and controls each part according to an application program downloaded in the memory 103.

In the memory 103, an application program, content information, etc., acquired via the optical disc 10 and the communication device 105 are downloaded. The optical disc drive 104 is provided with a configuration for reproducing the optical disc 10, and in response to a command from the CPU 102, reproduces the attached optical disc 10. The communication device 105 is provided with a configuration for connecting to an external network (Internet), and in response to a command from the CPU 102, connects to the external network to acquire predetermined information from a server device on the network.

The input device 106 is provided with an input key, together with an interface for receiving a signal from external input means such as a remote controller, and outputs a command inputted via these parts by a user to the CPU 102. The output device 107 is provided with an interface for outputting a signal to a monitor and a speaker, and in response to an instruction from the CPU 102, outputs a reproduction result of the application program or the content information to the monitor and speaker.

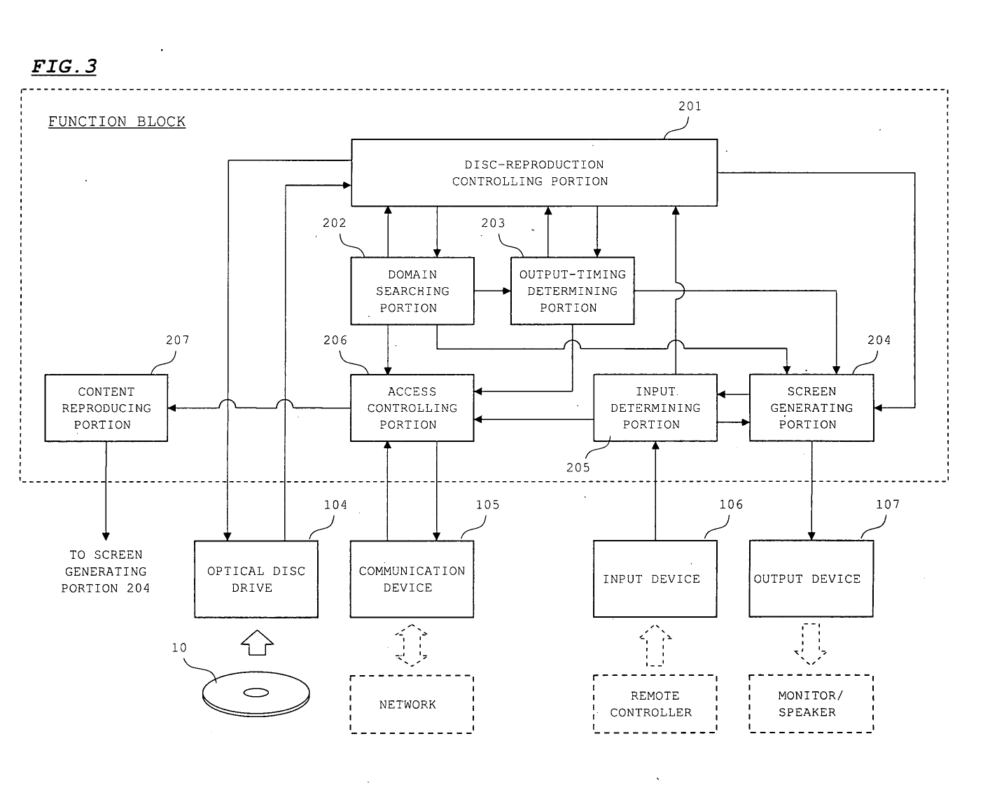

FIG. 3 is a diagram showing, as a function block, a function by the main program stored in the ROM 101. It is noted that FIG. 3 shows only a function block relating to a process when acquiring the content information from the server device using the optical disc 10.

The function block by the main program includes: a disc-reproduction controlling portion 201; a domain searching portion 202; an output-timing determining portion 203; a screen generating portion 204; an input determining portion 205, an access controlling portion 206; and a content reproducing portion 207.

The disc-reproduction controlling portion 201 controls the optical disc drive 10 to reproduce the optical disc 10, and also supplies various reproduced data to the corresponding function block (the domain searching portion 202, the output-timing determining portion 203, or the screen generating portion 204).

The domain searching portion 202 instructs the disc-reproduction controlling portion 201 to acquire the file in which whether there is setting relating to a network connection is set in Bits or the file written with the domain information (access destination address such as a URL), from the folder structure (tree structure) of the advanced content, and also refers to the file supplied from the disc-reproduction controlling portion 201 in response to the instruction so as to distinguish whether the domain information is included on the disc 10. The domain searching portion 202 then supplies the distinguishing result to the output-timing determining portion 203, the screen generating portion 204, and the access controlling portion 206. Further, the domain searching portion 202 acquires the domain information from the file written with the domain information (access destination address such as a URL), and supplies the same to the access controlling portion 206.

When the distinguishing result indicating that the domain information is included on the disc 10 is supplied from the domain searching portion 202, the output-timing determining portion 203 instructs the disc-reproduction controlling portion 201 to supply a signal indicating an end of the reproduction, for example, at the timing at which the reproduction of the main content (for example, a movie content) contained on the disc 10 is all ended. Then, at the timing at which the signal is supplied, the disc-reproduction controlling portion 201 supplies a timing signal to the screen generating portion 204 and the access controlling portion 206.

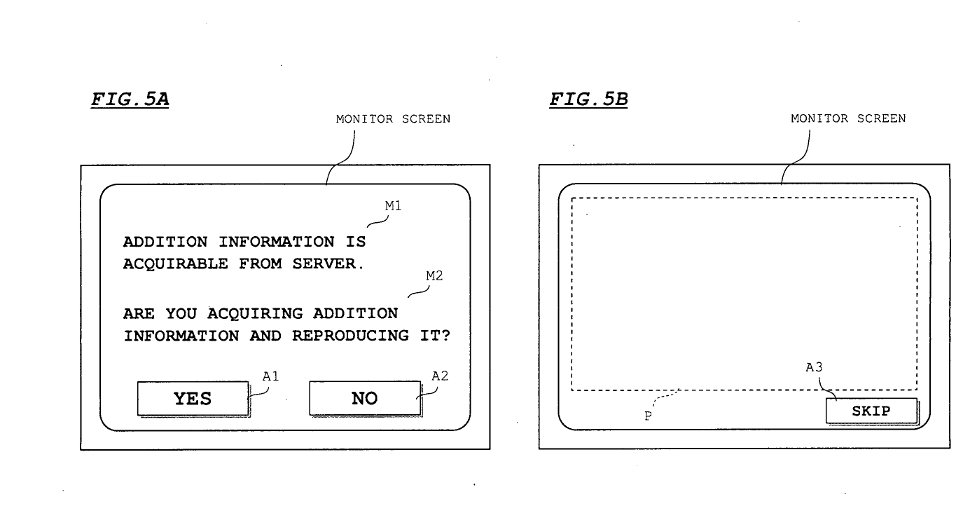

At the time of reproducing the main content, the screen generating portion 204 generates video data and audio data based on the reproduction data of the main content supplied from the disc-reproduction controlling portion 201, and supplies the both data to the output device 107. Also, the screen generating portion 204 supplies video data for outputting a screen shown in FIG. 5A to the output device 107, for example, when the distinguishing result indicating that the domain information is included on the disc 10 is supplied from the domain searching portion 202, at the timing at which the timing signal is supplied from the output-timing determining portion 203. It is noted that the screen in FIG. 5A includes: a message M1 indicating that an additional content is acquirable from the server device; a message M2 that inquires a users whether to acquire the additional content from the server device; and input buttons A1 and A2 used by the user to respond to the messages.

Further, the screen generating portion 204 supplies the output device 107 with video data for outputting a reproduction result in which the additional content acquired from the server device by way of a network, which is described later, is reproduced in the content reproducing portion 207. In this case, for example, a screen as shown in FIG. 5B is displayed on the monitor. With this screen format, the additional content is displayed in an area P. An input button A3 is a skip button used at the time of skipping the display of the additional content.

The input determining portion 205 determines an input command by the user based on a signal from the input device 106, and supplies the determination result to a corresponding function block. For example, in FIG. 5A, when the input button A1 is operated by the user, the input determining portion 205 determines that a command for acquiring the additional content from the server device is inputted by the user, and supplies the determination result to the access controlling portion 206 and the screen generating portion 204. Further, when the input button A2 is operated by the user, the input determining portion 205 determines that a command for not acquiring the additional content from the server device is inputted by the user, and supplies the determination result to the access controlling portion 206 and the screen generating portion 204.

When a timing signal is inputted from the output-timing determining portion 203 and also a signal indicating that an acquisition command of the additional content is inputted from the input determining portion 205 is inputted, the access controlling portion 206 executes access control for accessing the server device on the network based on the domain information supplied from the domain searching portion 202. Thereby, the communication device 105 accesses the server device on the network to acquire the additional content from the server device. The acquired additional content is supplied to the content reproducing portion 207.

The content reproducing portion 207 reproduces the acquired additional content according to the file format, and supplies the reproduction result to the screen generating portion 204. In receipt thereof, the screen generating portion 204 generates video data of a screen format shown in FIG. 5B, and supplies the generated video data to the output device 107.

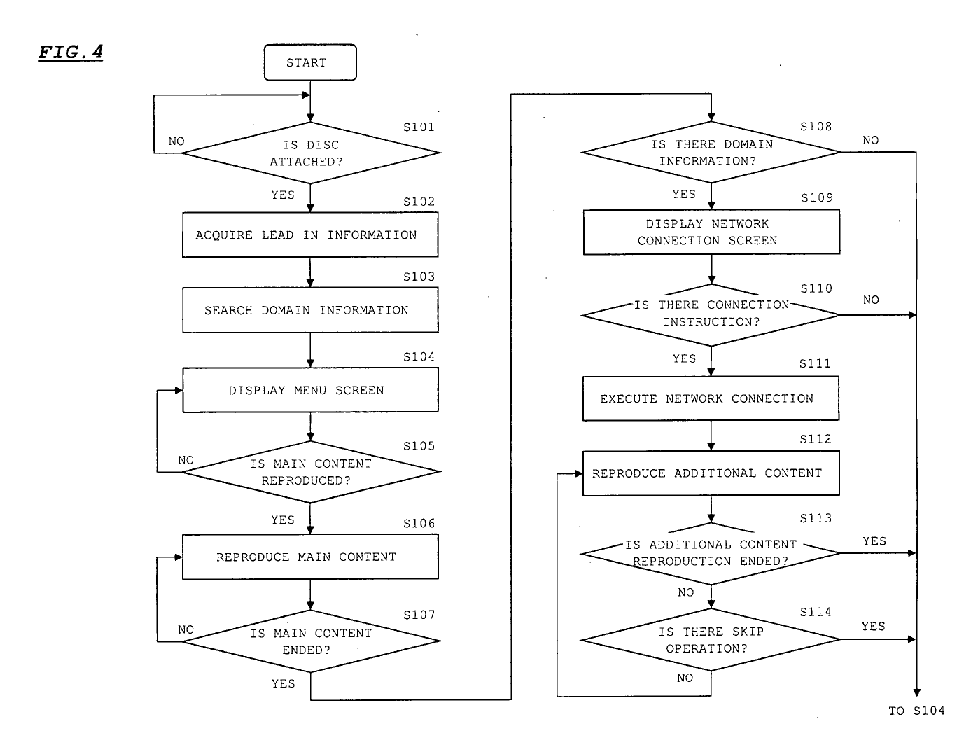

FIG. 4 is a diagram showing a process flow at the time of reproducing the disc 10 by the optical disc apparatus 100.

When the disc 10 is attached (S101: YES), system lead-in information is read out by the disc-reproduction controlling portion 210 and stored in the memory 103 (S102). Thereafter, the folder structure (tree structure) is tracked by the domain searching portion 202 as described above, and it is distinguished whether the domain information is included on the disc 10 (S103). Thereafter, a menu screen (an initial screen) for reproducing the disc 10 is generated by the screen generating portion 204 based on the data stored within the disc 10, and the generated menu screen is displayed on the monitor via the output device 107 (S104).

Afterwards, when a reproduction command of the main content (the movie content, etc.) is inputted by the user by operating the menu screen with a remote controller, etc. (S105: YES), the reproduction of the main content is performed by the disc-reproduction controlling portion 201, and video and audio of the main content are outputted from the monitor and the speaker (S106). Thereafter, when the reproduction of the main content is ended (S107: YES), the flow process is diverged depending on whether or not there is the domain information on the disc 10 (S108).

That is, when the domain searching portion 202 determines at S103 that the domain information is not included on the disc 10 (S108: NO), the screen generating portion 204 generates again the menu screen (the initial screen) for reproducing the disc 10, and displays the generated menu screen on the monitor via the output device 107 (S104).

On the other hand, when the domain searching portion 202 determines at S103 that the domain information is included on the disc 10 (S108: YES), the screen generating portion 204 is supplied with the timing signal from the output-timing determining portion 203 in response to the end of the reproduction of the main content, and a screen shown in FIG. 5A is generated by the screen generating portion 204 so that a connection to the network is made selectable. As a result, the generated screen is displayed on the monitor via the output device 107 (S109).

In the screen shown in FIG. 5A, when the input button A2 is operated by the user (S110: NO), the screen generating portion 204 generates again the menu screen (the initial screen) for reproducing the disc 10, and displays the generated menu screen on the monitor via the output device 107 (S104). On the other hand, when the input button A1 is operated by the user on the screen shown in FIG. 5A (S110: YES), the access controlling portion 206 executes the access control based on the domain information searched by the domain searching portion 202. Thereby, the corresponding server device is accessed via the communication device 105, and the additional content is acquired from the server device (S111).

The additional content thus acquired from the server device is reproduced by the content reproducing portion 207, and supplied to the screen generating portion 204 (S112). As a result, the screen generating portion 204 configures a screen in which the content of the additional content is allotted to the area P of the screen format shown in FIG. 5B, and displays the configured screen on the monitor via the output device 107. The reproduction display of the additional content is performed until either the reproduction of the additional content is all ended (S113: YES), or the input button A3 is operated in the screen in FIG. 5B (S114: YES). When the reproduction of the additional content is all ended (S113: YES), or when the input button A3 is operated (S114: YES), the screen generating portion 204 generates again the menu screen (the initial screen) for reproducing the disc 10, and displays the generated menu screen on the monitor via the output device 107 (S104).

As described above, according to the embodiment, the existence of the domain information on the disc 10 is presented to outside concurrently with the reproduction of the disc 10. Thus, even when the user loses a disc package or an instruction manual, for example, it is possible to know properly and smoothly that the domain information exists on the disc 10 and the additional content is acquirable from the server device by way of the network.

In addition, according to the embodiment, the screen in which whether to access an address specified by the domain information is selectable (for example, see FIG. 5A) is displayed to outside. Thus, the user is able to acquire the additional content by simply performing a predetermined operation (for example, operating the input button A1) according to the screen. Therefore, according to the embodiment, it is possible to avoid complicated operations, such as a forwarding operation of a function menu is repeated to execute a network access function, at the time of acquiring the additional content. This makes it convenient for users.

Further, according to the embodiment, there is no presentation of the domain information in the middle of the reproduction of the main content contained on the disc 10. Thus, the reproduction of the main content is not disturbed by the presentation of the domain information; therefore, it is possible to properly perform the reproduction of the main content which should be supposed to be mainly reproduced.

Particularly, according to the embodiment, the existence of the domain information is presented to outside at the timing at which the reproduction of the main content contained in the disc 10 is ended. Thus, it is possible to provide the additional content at the most effective timing to the user when the additional content acquired based on the domain information is associated with the main content contained in the disc 10. For example, according to the embodiment, when the movie content is contained on the disc 10, and the additional content provided from the server device is an additional content that introduces a sequel of the movie or an additional content that introduces a behind-the-movie-scene story, the user is presented with the introduction of the sequel or the behind-the-movie-scene story at the timing at which the echoes of excitement still remain immediately after the user has seen the movie. Therefore, for the user, the interest for the sequel is raised effectively or the amusement characteristic in the content of the movie is raised effectively. It is noted that after an elapse of a certain period since the display of the screen of FIG. 5A, the screen may be switched, regarding that the input button A2 is operated by the user.

It is noted that the present invention is by no means restricted by the above-described embodiment, and various types of modifications other than the embodiment of the present invention are possible.

For example, in the above-described embodiment, the screen for a network connection (see FIG. 5A) is displayed in response to the end of the reproduction of the main content; however, the screen for a network connection may be displayed before the reproduction of the main content.

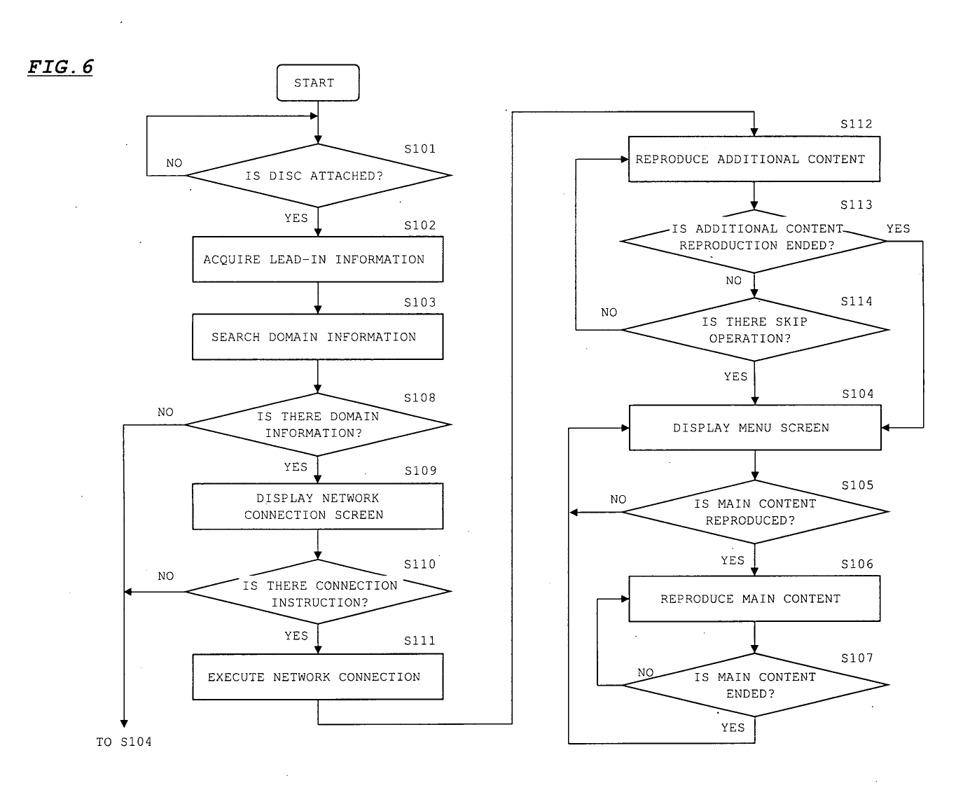

FIG. 6 shows a process flowchart in this case. That is, in the process flowchart, when the domain information is searched at S103, and it is thereby determined that there is the domain information on the disc 10 (S108: YES), a network connection screen shown in FIG. 5A is immediately displayed (S109). Thereafter, processes at S110 to S114 are similar to those in FIG. 4.

In the screen display in FIG. 5A, when the user operates the input button A2 (S110: NO), the menu screen (the initial screen) for reproducing the disc 10 is displayed on the monitor, and the process is shifted to the reproduction of the main content (S104). On the other hand, when the user operates the input button A1 (S110: YES) on the screen display in FIG. 5A, the additional content is reproduced and displayed (S111 to S114). In this case also, similar to the case in FIG. 4, the additional content is reproduced and displayed either until the reproduction of the additional content is all ended (S113: YES), or until the input button A3 is operated on the screen in FIG. 5B (S114: YES). When the reproduction of the additional content is all ended (S113: YES) or the input button A3 is operated (S114: YES), the menu screen (the initial screen) for reproducing the disc 10 is displayed on the monitor, and the process is shifted to the reproduction of the main contents (S104).

According to the process flow in FIG. 6, the existence of the domain information is presented to outside at the timing before the reproduction of the main content recorded on the disc 10 is started, and thus, the user is able to surely know the existence of the domain information. That is, the existence of the domain information is presented after the disc is attached and before the menu screen (the initial screen) for reproducing the disc is displayed; therefore, the domain information is surely presented to the user, allowing the user to surely recognize, without overlooking, the presentation of the domain information.

It is noted that according to the process flow in FIG. 6, the user is able to shift to the reproduction of the main content by operating the input button A2 on the screen display in FIG. 5A or by operating the input button A3 on the display screen in FIG. 5B, for example. Thus, even when it is desirable to view the main content in advance, it is possible to promptly shift the process to the reproduction of the main content. In this case also, the user is deemed to see the screen display in FIG. 5A all the time; therefore, the user is able to surely know that the additional content is acquirable, and it is possible to smoothly shift the process to the reproduction of the additional content after the reproduction of the main content, for example.

In the process flow in FIG. 4, the screen for a network connection is displayed at the time of ending the reproduction of the main content, and in the process flow in FIG. 6, the screen for a network connection is displayed before the start of the reproduction of the main content. However, for example, a message informing that the additional content is acquirable from the network may be displayed to be superimposed over the reproduced image of the main content, allowing the user to know that the additional content is acquirable. However in this case, the message is displayed to be superimposed over the reproduced image of the main content, and thus, the reproduced image of the main content is disturbed by this message, which may cause a problem in the viewing of the main content. In this case, it is necessary for the user to operate the network connection. Therefore, to avoid this problem, it is desirable to display the screen for a network connection at the time of ending, or before starting, the reproduction of the main contents, as described-above. Further, it is desirable to display the existence of the domain information only once after the disc is inserted, assuming that the main content is repeatedly reproduced, etc. This eliminates a need of performing a skip operation each time the user repeatedly reproduces the main content.

In addition, an HD is used as the disc 10 in the embodiment. However, other media such as a blue-ray disc may be used, and a plurality of recording layers may be included on the disc 10.

The embodiment of the present invention may be appropriately modified in various ways without departing from the technological ideas described in the claims.

What is claimed is:

1. An optical disc apparatus, comprising:
a domain searching portion for searching domain information from information stored on a disc;
a domain presenting portion for presenting existence of the domain information to outside at a predetermined timing in a reproducing process of the disc when the domain information is searched by the domain searching portion; and
an access controlling portion for accessing an address specified by the domain information via a network when an access execution command based on the domain information is inputted by a user.

2. The optical disc apparatus according to claim 1, wherein
the domain presenting portion includes a process for displaying to outside a screen in which whether the address specified by the domain information is accessed is selectable,
the access controlling portion includes a process for accessing the address specified by the domain information via the network based on the screen displayed by the domain presenting portion when a selection operation for executing the access is performed by the user.

3. The optical disc apparatus according to claim 1, wherein
the domain presenting portion executes a process for presenting to outside the existence of the domain information at a timing at which reproduction of a main content recorded on the disc is ended.

4. The optical disc apparatus according to claim 1, wherein
the domain presenting portion executes a process for presenting to outside the existence of the domain information at a timing at which reproduction of a main content recorded on the disc is started.
